(19) United States
(12) Patent Application Publication
(10) Pub. No.: US 2025/0316925 A1
(43) Pub. Date: Oct. 9, 2025

(54) Case, Partition and Electrical Connector

(71) Applicant: TE Connectivity Japan G.K., Kawasaki-shi (JP)

(72) Inventor: Masaaki Saito, Kawasaki-shi (JP)

(73) Assignee: TE Connectivity Japan G.K., Kawasaki-shi (JP)

(21) Appl. No.: 19/170,127

(22) Filed: Apr. 4, 2025

(30) Foreign Application Priority Data
Apr. 5, 2024 (JP) 2024-061147

(51) Int. Cl. H01R 13/514

(52) U.S. Cl. CPC H01R 13/514

(57) ABSTRACT

A case includes a housing space accommodating a plurality of housings and a plurality of partition member fixing parts in which the housings are arranged. The housings are arranged side by side in a first direction that intersects a pull-out direction of an electric wire from the case. The partition member fixing parts are provided in the first direction and are respectively provided offset from a center of the housing space in the first direction.

### CROSS-REFERENCE TO RELATED APPLICATIONS

This application claims the benefit of the filing date under 35 U.S.C. § 119(a)-(d) of Japanese Patent Application No. JP 2024-061147, filed on Apr. 5, 2024.

### FIELD OF THE INVENTION

The present invention relates to a case and, more particularly, to a case for an electrical connector, a partition that divides the inside of the case, and the electrical connector.

### BACKGROUND OF THE INVENTION

An electric motor includes a motor-side electrical connector to receive power and a control signal. A motor electrical connector for supplying power and a control signal is mated with and connected to the motor-side electrical connector.

The motor electrical connector includes a case, a housing to be accommodated in the case, and terminals retained in the housing. An arrangement of the terminals retained in the housing corresponds to an arrangement of terminals of the motor-side connector to be mated. In the motor electrical connector, an electric wire is pulled out. A direction in which the electric wire is pulled out (a pull-out direction) differs depending on, for example, an environment in which a motor is used.

JP2018-045836A describes an electrical connector capable of optionally selecting a pull-out direction of an electric wire. As illustrated in FIG. 17 in JP2018-045836A, the electrical connector in JP2018-045836A is provided with a partition that divides a housing space in a case that accommodates housings into a left space and a right space.

In the electrical connector in JP2018-045836A, the left space accommodates a power supply housing that retains power supply terminals, and the right space accommodates a signal housing that retains signal terminals. The power supply housing and the signal housing in JP2018-045836A are equal in dimension in a left-right direction. Therefore, the partition divides the housing space in the case that accommodates the housings that are bilaterally symmetrical. In this case, the partition is provided in a fixed location at the center in the right-left direction, i.e., in an arrangement direction of the housings.

However, the dimension of the power supply housing and the dimension of the signal housing in the arrangement direction may differ, for example. When the two housings respectively having different dimensions are accommodated, the housing space in the case is asymmetrically divided in the arrangement direction by the partition. In the electrical connector in which the housing space of the case is asymmetrically divided, if the pull-out direction of the electric wire is reversed, for example, respective locations in the arrangement direction of the power supply housing and the signal housing need to be exchanged in response thereto. The power supply housing, which is positioned in the right housing space, and the signal housing, which is positioned in the left housing space, are respectively positioned in the left housing space and the right housing space. Therefore, a location of the partition needs to be changed depending on a difference between the respective dimensions in the left-right direction of the power supply housing and the signal housing. Accordingly, two types of cases that differ in the location of the partition are required.

### SUMMARY OF THE INVENTION

A case includes a housing space accommodating a plurality of housings and a plurality of partition member fixing parts in which the housings are arranged. The housings are arranged side by side in a first direction that intersects a pull-out direction of an electric wire from the case. The partition member fixing parts are provided in the first direction and are respectively provided offset from a center of the housing space in the first direction.

### BRIEF DESCRIPTION OF DRAWINGS

The invention will now be described by way of example with reference to the accompanying figures, of which:

FIG. 1 is an exploded view of an electrical connector according to an exemplary embodiment;

FIG. 2 is a bottom view of a case according to an exemplary embodiment;

FIG. 3 is an isometric view of a partition according to an exemplary embodiment;

FIG. 4 is a bottom view of the partition of FIG. 3;

FIG. 5 is a bottom view of a mating connector to be mated with the electrical connector of FIG. 1 according to an exemplary embodiment;

FIG. 6 is a bottom view of the electrical connector of FIG. 1 having a first housing and a second housing accommodated in the case of FIG. 2 in a first arrangement; and

FIG. 7 is a bottom view of the electrical connector of FIG. 1 having the first housing of FIG. 6 and the second housing of FIG. 6 accommodated in the case of FIG. 2 in a second arrangement.

### DETAILED DESCRIPTION

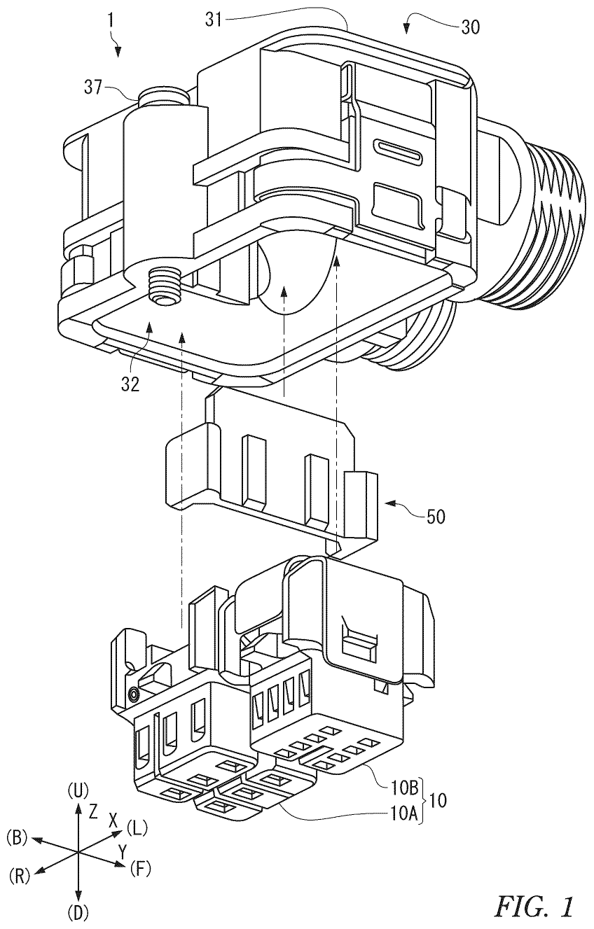

An exemplary embodiment of an electrical connector 1 is now described with reference to FIGS. 1-4 and 6-7.

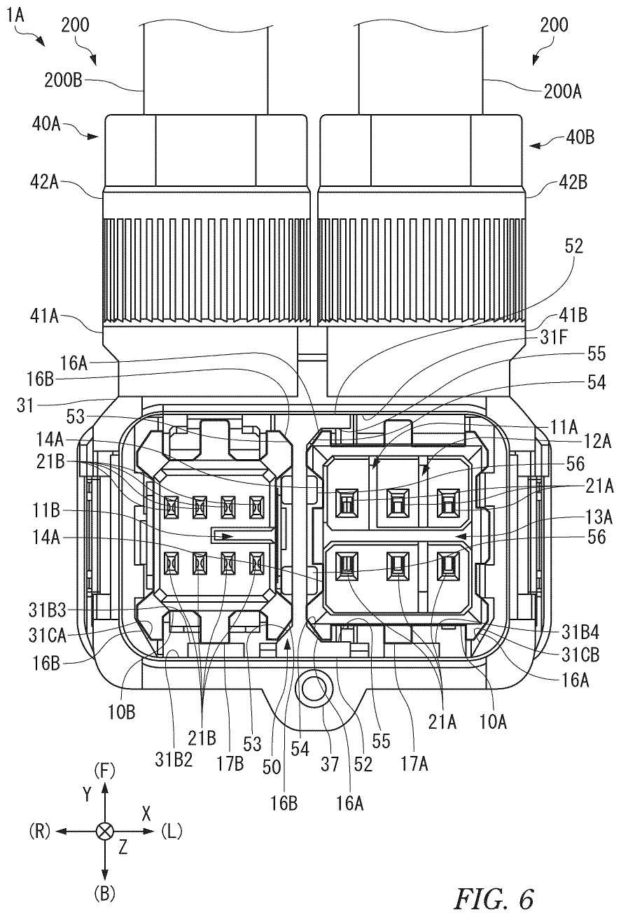

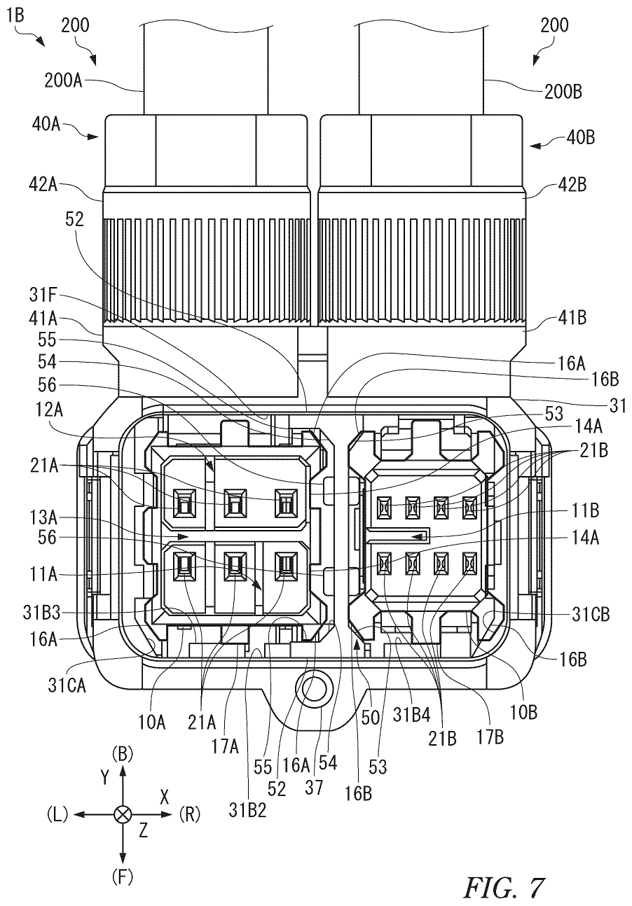

The electrical connector 1 includes two housings 10, i.e., a first housing 10A and a second housing 10B, and a case 30. The first housing 10A and the second housing 10B may be collectively referred to as the housing 10, housings 10, etc. With the electrical connector 1, even if a pull-out direction of an electric wire 200 is changed (e.g., see FIGS. 6 and 7), a housing space 32 that accommodates the first housing 10A and the second housing 10B can be asymmetrically divided by changing a location of a partition 50. That is, the electrical connector 1 can cope with respective position changes of the first housing 10A and the second housing 10B while only using one type of case 30.

For convenience of description, as illustrated in each of the drawings, various directions are shown. The various directions are defined as follows: a direction in which the housings 10 to be accommodated in the case 30 are arranged is set as a first direction X; the rightward side and the leftward side in the first direction X are respectively set as (R) and (L); an electric wire pull-out direction, which intersects the first direction X and in which the electric wire is pulled out of the case 30, is set as a second direction Y; the forward side and the backward side in the second direction Y are respectively set as (F) and (B); a mating direction in which the electrical connector 1 is mated with a mating connector 100 is set as a third direction Z; and the upward side and the downward side in the third direction Z are respectively set as (U) and (D). In the present embodiment, the first direction X and the second direction Y are perpendicular to each other.

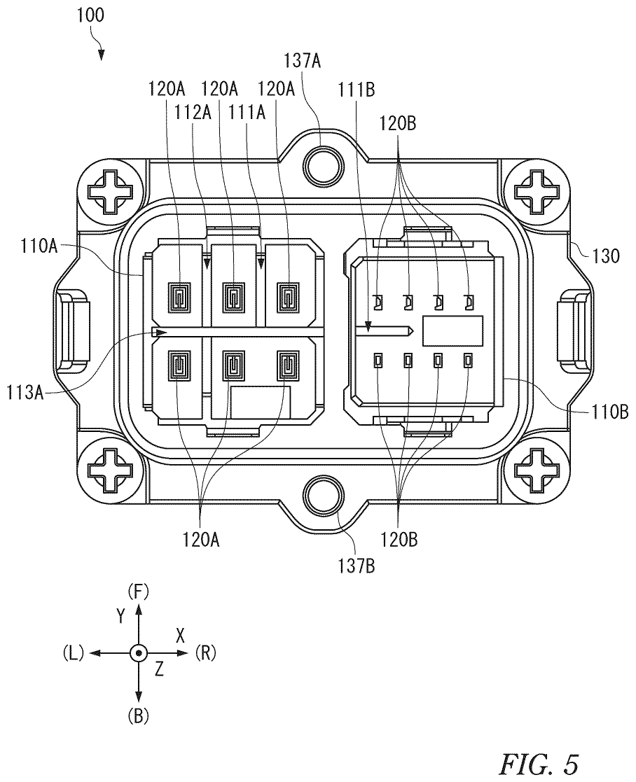

In FIGS. 5-7, the first direction X, the second direction Y, and the third direction Z are displayed such that respective directions after the mating of the electrical connector 1 and the mating connector 100 match each other.

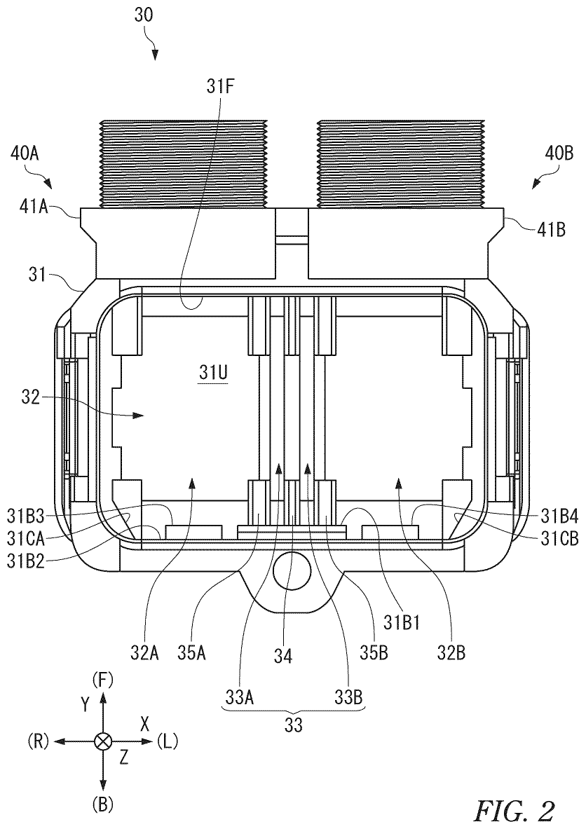

As shown in FIG. 1, the electrical connector 1 includes the first housing 10A and the second housing 10B each retaining terminals, and the case 30 having a housing space 32 that accommodates the housings 10. A partition 50, as shown in FIGS. 1 and 3-4, that divides the housing space 32 into two spaces 32A, 32B, as shown in FIG. 2, is attached to the case 30. The electrical connector 1 is, for example, an electrical connector to be mated with a mating connector 100 as a motor-side connector.

As shown in FIGS. 1-2, the case 30 includes a case body 31 having the housing space 32. The housing space 32 is a rectangular parallelepiped-shaped space surrounded by the case body 31. The shape of the housing space 32 corresponds to an external shape of the housings 10. The plurality of housings 10, i.e., the first housing 10A and the second housing 10B, are accommodated side by side in the housing space 32. As shown in FIG. 2, the case body 31 has a rectangular cylindrical-shaped form and includes a front wall face 31F, a first back wall face 31B1, a second back wall face 31B2, a third back wall face 31B3, a fourth back wall face 31B4, a first taper 31CA, a second taper 31CB, and an upper wall face 31U to face the housing space 32. A bolt 37, as shown in FIGS. 1 and 6-7, for fastening to the mating connector 100, is attached to the outer periphery of the case body 31. The case body 31 is formed as a single member by injection molding of a resin material. The resin material is an electrically insulating material.

As shown in FIG. 2, a first housing space 32A and a second housing space 32B are respectively formed on the rightward side R in the first direction X and the leftward side L in the first direction X in the housing space 32. In other words, the first housing space 32A is formed on the left side of the paper plane of FIG. 2 and the second housing space 32B is formed on the right side of the paper plane of FIG. 2.

The first housing space 32A and the second housing space 32B differ in dimension in the first direction X depending on a location in the first direction X of the partition 50. That is, as shown in FIGS. 6-7, depending on where the partition 50 is located, the case 30 may have: (1) the first housing space 32A which is larger in dimension than the second housing space 32B; or (2) the first housing space 32A which is smaller in dimension than the second housing space 32B. As shown in FIGS. 6-7, the first housing 10A is positioned in the first housing space 32A or the second housing space 32B having the larger dimension, and the second housing 10B is positioned in the first housing space 32A or the second housing space 32B having the smaller dimension. Thus, as shown in FIGS. 6-7, the first housing space 32A and the second housing space 32B vary in volume depending on a location of the partition 50.

As shown in FIG. 2, a mating groove 33 is formed in the case body 31. The mating groove 33 is formed in a central portion in the first direction X of the case body 31, and is a partition member fixing part which locates and fixes the partition 50. As shown in FIG. 2, the mating groove 33 includes a first mating groove 33A provided on the rightward side R in the first direction X, and a second mating groove 33B provided on the leftward side L in the first direction X. That is, the first mating groove 33A and the second mating groove 33B are each one of a plurality of partition member fixing parts formed in the case body 31.

As shown in FIG. 2, the first mating groove 33A is provided in a location offset from the center toward the rightward side R, and the second mating groove 33B is provided in a location offset from the center toward the leftward side L. The first mating groove 33A and the second mating groove 33B are respectively provided in symmetrical locations with respect to the center, and are parallel to each other.

As shown in FIG. 2, the first mating groove 33A is formed to connect with the front wall face 31F, the upper wall face 31U, and the first back wall face 31B1, and has a C-shaped form. Similarly, the second mating groove 33B is formed to connect with the front wall face 31F, the upper wall face 31U, and the first back wall face 31B1, and has a C-shaped form.

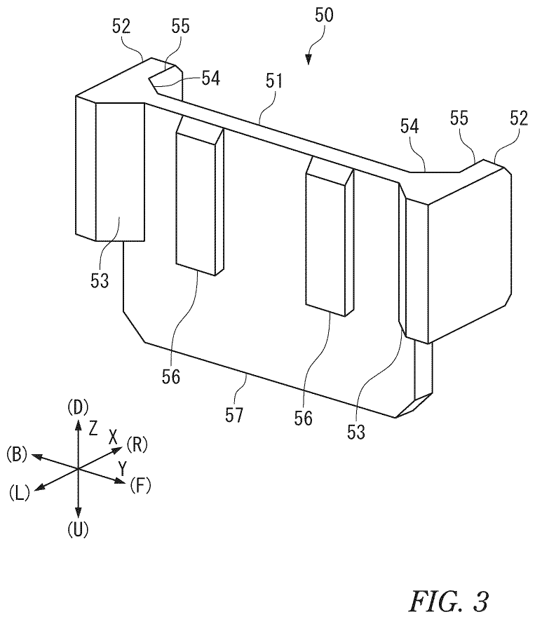

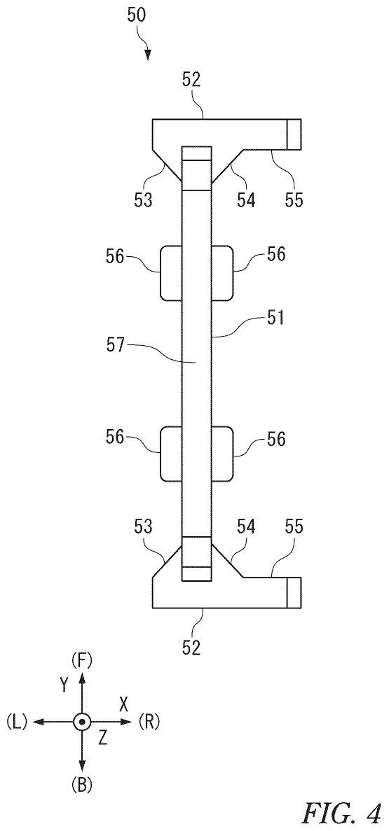

An insertion part 57 of the partition 50, as shown in FIGS. 3-4, is fitted into the first mating groove 33A or the second mating groove 33B (see FIGS. 6-7). The insertion part 57 fixes the partition 50 to the case body 31.

As shown in FIG. 2, a central guide 34 is formed in the case body 31. The central guide 34 is provided between the first mating groove 33A and the second mating groove 33B. A right guide 35A, shown in FIG. 2, is also formed in the case body 31. The right guide 35A is provided on the rightward side R of the first mating groove 33A. As shown in FIG. 2, a left guide 35B is also formed in the case body 31. The left guide 35B is provided on the leftward side L of the second mating groove 33B. The central guide 34 is formed to protrude toward the housing space 32 side to connect with the front wall face 31F, the upper wall face 31U, and the first back wall face 31B1, and has a C-shaped form. In the central guide 34, a protrusion amount of a portion on the front wall face 31F side and a portion on the first back wall face 31B1 side is larger than a protrusion amount of a central portion between the front wall face 31F and the first back wall face 31B1. The right guide 35A and the left guide 35B respectively have similar forms.

The central guide 34 and the right guide 35A locate the insertion part 57 in the first direction X and guide the partition 50 into the first mating groove 33A. The central guide 34 and the left guide 35B locate the insertion part 57 in the first direction X and guide the partition 50 into the second mating groove 33B.

As shown in FIGS. 6-7, a first electric wire pull-out tube 40A and a second electric wire pull-out tube 40B are formed in the case body 31. The first electric wire pull-out tube 40A and the second electric wire pull-out tube 40B are formed on the forward side F in the second direction Y of the case body 31. The electric wire 200, which is connected to the terminals in the housings 10, is inserted into both the first electric wire pull-out tube 40A and the second electric wire pull-out tube 40B. The first electric wire pull-out tube 40A and the second electric wire pull-out tube 40B are formed on the case body 31 in a direction in which the first electric wire pull-out tube 40A and the second electric wire pull-out tube 40B each pull out the electric wire 200 in the case 30. That is, there is a configuration of the case 30 where the electric wire 200 is pulled out toward the forward side F, as shown in FIG. 6, and a configuration of the case 30 where the electric wire 200 is pulled out toward the backward side B, as shown in FIG. 7. However, even if the direction in which the electric wire 200 is pulled out is reversed, the case 30 can accommodate both pull out directions rather than requiring two different cases for each pull out direction. The electric wire 200 is a general name for a power line 200A and a control line 200B.

As shown in FIGS. 6-7, the first electric wire pull-out tube 40A includes an insertion tube 41A extending from the case body 31 toward the forward side F in the second direction Y. The first electric wire pull-out tube 40A also includes a tightening nut 42A mutually fastened to the insertion tube 41A. As further shown in FIGS. 6-7, the second electric wire pull-out tube 40B includes an insertion tube 41B extending from the case body 31 toward the forward side F in the second direction Y. The second electric wire pull-out tube 40B also includes a tightening nut 42B mutually fastened to the insertion tube 41B.

As shown in FIG. 6, the third back wall face 31B3 guides the locating parts 17B in the second housing 10B, and locates the second housing 10B in the second direction Y. As further shown in FIG. 6, the fourth back wall face 31B4 guides the locating parts 17A in the first housing 10A and locates the first housing 10A in the second direction Y.

As shown in FIG. 7, the third back wall face 31B3 guides the locating parts 17A in the first housing 10A, and locates the first housing 10A in the second direction Y in. As further shown in FIG. 7, the fourth back wall face 31B4 guides the locating parts 17B in the second housing 10B and locates the second housing 10B in the second direction Y.

The first taper 31CA guides the slope parts 16B in the second housing 10B in FIG. 6, and guides the slope parts 16A in the first housing 10A in FIG. 7. The second taper 31CB guides the slope parts 16A in the first housing 10A in FIG. 6, and guides the slope parts 16B in the second housing 10B in FIG. 7.

As shown in FIG. 1, the two housings 10 have different functions. The first housing 10A retains the terminals to which the power line 200A for power and brake is connected, and the second housing 10B retains the terminals to which the control line 200B for an encoder is connected. Even if the pull-out direction of the electric wire 200 is reversed, a connection relationship between the first housing 10A and the power line 200A and a connection relationship between the second housing 10B and the control line 200B remain the same.

Both the first housing 10A and the second housing 10B have a rectangular parallelepiped-shaped form. The first housing 10A and the second housing 10B are the same in respective dimensions in the second direction Y and the third direction Z, but the first housing 10A is larger than the second housing 10B in dimension in the first direction X. Due to differences in the dimensions, if the direction in which the electric wire 200 is pulled out is reversed, a position of the partition 50 is changed (e.g., different positions of the partition 50 are shown in FIG. 6 and FIG. 7). The first housing 10A and the second housing 10B are each formed of a single member by injection molding of a resin material. The resin material is an electrically insulating material.

As shown in FIGS. 6-7, the first housing 10A has a first keyway 11A and a second keyway 12A extending in the second direction Y, and a third keyway 13A extending in the first direction X formed on its bottom surface. The first housing 10A also has a side guide 14A along a shape of the partition 50 formed on its side surface extending in the second direction Y. As shown in FIGS. 6-7, the slope parts 16A are formed in the four corners of the first housing 10A. The slope parts 16A facilitate insertion of the first housing 10A into the case 30. The locating parts 17A are formed on both sides of the first housing 10A in the second direction Y. The locating parts 17A are to be located, in the second direction Y, on the third back wall face 31B3 or the fourth back wall face 31B4 in the case 30. The first housing 10A retains a plurality of terminals 21A, as shown in FIGS. 6-7, to be connected to the power line 200A.

As shown in FIGS. 6-7, a first keyway 11B extending in the first direction X is formed in the second housing 10B. The slope parts 16B are formed in the four corners of the second housing 10B. The slope parts 16B facilitate insertion of the second housing 10B into the case 30. The locating parts 17B are formed on both sides of the second housing 10B in the second direction Y. The locating parts 17B are to be located, in the second direction Y, on the third back wall face 31B3 or the fourth back wall face 31B4 in the case 30. The second housing 10B retains a plurality of terminals 21B, as shown in FIGS. 6-7, to be connected to the control line 200B.

As shown in FIGS. 6-7, the partition 50 is attached to the case 30. The partition 50 ensures an insulation distance between the first housing 10A and the second housing 10B. In other words, the partition 50 ensures that the first housing 10A and the second housing 10B are electrically insulated from each other. When an insulation distance between the first housing 10A and the second housing 10B is ensured, an effect of electromagnetic noise due to a current that passes through the terminals 21A and a communication signal that passes through the terminal 21B can be reduced.

As shown in FIGS. 2 and 6-7, when the partition 50 is attached to the case 30 the partition 50 divides the housing space 32 into the first housing space 32A and the second housing space 32B. The first housing 10A and the second housing 10B are respectively accommodated in the first housing space 32A and the second housing space 32B that are defined by the partition 50. When the electric wire 200 is pulled out toward the forward side F, the second housing 10B is positioned in the first housing space 32A and the first housing 10A is positioned in the second housing space 32B. When the electric wire 200 is pulled out toward the backward side B, the first housing 10A is positioned in the first housing space 32A and the second housing 10B is positioned in the second housing space 32B.

As shown in FIG. 1, the partition 50 is a separate member from the case 30. The partition 50 is formed as a separate member from the case 30 by injection molding of a resin material. The resin material is an electrically insulating material. The partition 50 is configured to be detachably attached to the mating groove 33 in the case 30. The partition 50 is positioned in the first mating groove 33A when the electric wire 200 is pulled out from the forward side F, and is positioned in the second mating groove 33B when the electric wire 200 is pulled out from the backward side B.

As shown in FIGS. 3-4, the partition 50 is provided with a partition part 51 that divides the housing space 32 into the first housing space 32A and the second housing space 32B. The partition part 51 has a rectangular plate-shaped form. When the first direction X is set as a plate thickness direction of the partition part 51, the second direction Y is set as a longitudinal direction of the partition part 51, and the third direction Z is set as a direction perpendicular to the longitudinal direction of the partition part 51.

As shown in FIGS. 3-4, abutment parts 52 are respectively formed on both sides of the partition part 51 in the longitudinal direction of the partition part 51. Each of the abutment parts 52 extends from an end in the longitudinal direction of the partition part 51 toward both sides in the plate thickness direction. A length in which the abutment part 52 extends toward one of both the sides in the plate thickness direction is larger than a length in which the abutment part 52 extends toward the other side. In a direction in which the partition part 51 extends in the direction perpendicular to the longitudinal direction, the abutment part 52 extends to a length exceeding approximately half the length of the partition part 51.

As shown in FIGS. 3-4, a first slope part 53 and a second slope part 54 of the partition 50 are formed in a corner portion where the partition part 51 and the abutment part 52 connect with each other. The first slope part 53 forms an angle of approximately 45 degrees with respect to the partition part 51 when viewed in the direction perpendicular to the longitudinal direction. The first slope part 53 extends from a distal end of a portion extending toward the other side in the plate thickness direction of the abutment part 52 toward the partition part 51. The second slope part 54 is formed to be line-symmetrical to the first slope part 53 with respect to the center of the plate thickness in the plate thickness direction of the partition part 51.

As shown in FIGS. 3-4, a portion further extending beyond the second slope part 54 toward the one side in the plate thickness direction is hereinafter referred to as a longitudinal part 55 of the abutment part 52.

As shown in FIGS. 3-4, two side guides 56 are formed on each of both the sides in the plate thickness direction of the partition part 51. The side guides 56 are respectively formed to protrude from surfaces on both the sides in the plate thickness direction of the partition part 51 in a location offset from the center in the longitudinal direction of the partition part 51. As shown in FIG. 3, the side guide 56 extends to the same length as that of the abutment part 52 in a direction in which the abutment part 52 extends in the direction perpendicular to the longitudinal direction.

As shown in FIGS. 3-4, the insertion part 57 of the partition 50 is provided at an end on the opposite side to the side on which the abutment parts 52 in the direction perpendicular to the longitudinal direction of the partition part 51 are formed. The insertion part 57, being located in the first direction X, is guided by the central guide 34 and the right guide 35A or the central guide 34 and the left guide 35B in the case 30.

As shown in FIG. 2, when the partition 50 is inserted into the first mating groove 33A, the second housing space 32B on the rightward side R becomes narrower and the first housing space 32A on the leftward side L becomes wider in the first direction X. As shown in FIG. 7, in this case, the second housing 10B is positioned in the second housing space 32B and the first housing 10A is positioned in the first housing space 32A. That is, the partition 50 asymmetrically divides the housing space 32 in the first direction X in which the first housing 10A and the second housing 10B are arranged to be narrower on the rightward side R and wider on the leftward side L.

On the other hand, as shown in FIG. 2, when the partition 50 is inserted into the second mating groove 33B the second housing space 32B on the rightward side R becomes wider and the first housing space 32A on the leftward side L becomes narrower in the first direction X. As shown in FIG. 6, in this case, the first housing 10A is positioned in the second housing space 32B and the second housing 10B is positioned in the first housing space 32A. That is, the partition 50 asymmetrically divides the housing space 32 in the first direction X to be wider on the rightward side R and narrower on the leftward side L. That is, the partition 50 can be attached to the mating grooves 33 respectively provided in different locations in the first direction X of the case 30.

As shown in FIG. 6, when the partition 50 is mated with the first mating groove 33A, the abutment parts 52 respectively abut the front wall face 31F and the second back wall face 31B2 of the case 30. Since the abutment parts 52 are respectively provided with the longitudinal parts 55, respective dimensions in which the abutment parts 52 abut the front wall face 31F and the second back wall face 31B2 of the case 30 increase so that the partition 50 can be stably attached to the case 30. The first slope part 53 guides the slope part 16B in the second housing 10B, the second slope part 54 guides the slope part 16A in the first housing 10A, and the side guide 56 guides the side guide 14A in the first housing 10A.

As shown in FIG. 7, when the partition 50 is mated with the second mating groove 33B, the abutment parts 52 respectively abut the front wall face 31F and the second back wall face 31B2 of the case 30. Like in FIG. 6, the first slope part 53 guides the slope part 16B in the second housing 10B, the second slope part 54 guides the slope part 16A in the first housing 10A, and the side guide 56 guides the side guide 14A in the first housing 10A.

An exemplary embodiment of the mating connector 100 is now described with reference to FIG. 5. As shown in FIG. 5, the mating connector 100 includes a third housing 110A, a fourth housing 110B, and a motor-side case 130 that accommodates the third housing 110A and the fourth housing 110B. The third housing 110A mates with the first housing 10A, and the fourth housing 110B mates with the second housing 10B. Even if the pull-out direction of the electric wire 200 in the electrical connector 1 toward the mating connector 100 is reversed, respective positions of the third housing 110A and the fourth housing 110B remain the same.

As shown in FIG. 5, a first key 111A, a second key 112A, and a third key 113A are formed in the third housing 110A. The first key 111A and the second key 112A extend in the second direction Y, and the third key 113A extends in the first direction X. When the third housing 110A is mated with the first housing 10A, the first key 111A, the second key 112A, and the third key 113A are formed on a surface (which opposes the first housing 10A) of the third housing 110A. The third housing 110A retains a plurality of terminals 120A to be electrically connected to the plurality of terminals 21A in the first housing 10A.

As shown in FIG. 5, a first key 111B extending in the first direction X is formed in the fourth housing 110B. When the fourth housing 110B is mated with the second housing 10B, the first key 111B is formed on a surface (which opposes the second housing 10B) of the fourth housing 110B. The fourth housing 110B retains a plurality of terminals 120B to be electrically connected to the plurality of terminals 21B in the second housing 10B.

As shown in FIG. 5, the motor-side case 130 is provided with a first female thread 137A and a second female thread 137B. The first female thread 137A is provided on the forward side F in the second direction Y of the motor-side case 130, and the second female thread 137B is provided on the backward side B in the second direction Y of the motor-side case 130. When the electric wire 200 is pulled out toward the backward side B, the bolt 37 in the case 30 is fastened to the first female thread 137A. On the other hand, when the direction in which the electric wire 200 is pulled out is reversed, i.e., the electric wire 200 is pulled out toward the forward side F, the bolt 37 in the case 30 is fastened to the second female thread 137B. Depending on the direction in which the electric wire 200 is pulled out, the first female thread 137A and the second female thread 137B are separately used.

In a motor provided with the mating connector 100, the electric wire 200 is pulled out toward either the forward side F or the backward side B in the second direction Y. Since the mating connector 100 is fixed to the motor, respective positions of the third housing 110A and the fourth housing 110B remain the same. Therefore, respective positions of the first housing 10A and the second housing 10B in the electrical connector 1 are changed. However, a location of the partition 50, which is positioned between the first housing 10A and the second housing 10B, is changed depending on the direction in which the electric wire 200 is pulled out. A configuration of the electrical connector 1, as shown in FIG. 6, is an electrical connector 1A in which the electric wire 200 is pulled out toward the forward side F. Another configuration of the electrical connector 1, as shown in FIG. 7, is an electrical connector 1B in which the electric wire 200 is pulled out toward the backward side B.

As shown in FIG. 6, in the electrical connector 1A, the first housing 10A is positioned in the second housing space 32B on the rightward side R with respect to the partition 50, and the second housing 10B is positioned in the first housing space 32A on the leftward side L with respect to the partition 50. As shown in FIG. 7, in the electrical connector 1B, the second housing 10B is positioned in the second housing space 32B on the rightward side R with respect to the partition 50, and the first housing 10A is positioned in the first housing space 32A on the leftward side L with respect to the partition 50.

For example, when a request for the electric wire 200 to be pulled out toward the forward side F in the second direction Y is coped with, the electrical connector 1A, as shown in FIG. 6, is mated with the mating connector 100. When the mating connector 100 is mated with the electrical connector 1A, the first key 111A, the second key 112A, and the third key 113A in the third housing 110A, which respectively correspond to the first keyway 11A, the second keyway 12A, and the third keyway 13A in the first housing 10A, are mated therewith. Consequently, each keyway in the first housing 10A and one key in the third housing 110A are mated with each other, and the first key 111B in the fourth housing 110B, which corresponds to the first keyway 11B in the second housing 10B, is mated therewith.

The electrical connector 1A and the mating connector 100 are normally mated with each other if each key and one keyway are mated with each other. The electrical connector 1A and the mating connector 100 are unsuccessfully mated with each other if the key and keyway are not mated with each other. Accordingly, it is possible to prevent the electrical connector 1A and the mating connector 100 from being erroneously mated with each other. After the electrical connector 1A and the mating connector 100 are mated with each other, the bolt 37 is fastened to the second female thread 137B.

As another example, when a request for the electric wire 200 to be pulled out toward the backward side B in the second direction Y is coped with, the electrical connector 1B, as shown in FIG. 7, is mated with the mating connector 100. When the mating connector 100 is mated with the electrical connector 1B, the first key 111A, the second key 112A, and the third key 113A in the third housing 110A, which respectively correspond to the first keyway 11A, the second keyway 12A, and the third keyway 13A in the first housing 10A, are mated therewith. Consequently, each keyway in the first housing 10A and one key in the third housing 110A are mated with each other, and the first key 111B in the fourth housing 110B, which corresponds to the first keyway 11B in the second housing 10B, is mated therewith. Consequently, the key and the keyway are mated with each other, thereby making it possible to prevent the electrical connector 1B and the mating connector 100 from being erroneously mated with each other. After the electrical connector 1B and the mating connector 100 are mated with each other, the bolt 37 is fastened to the first female thread 137A.

Effects of the electrical connector 1 are now described.

The electrical connector 1 includes the two housings 10, i.e., the first housing 10A and the second housing 10B, and the case 30 that asymmetrically divides the housing space 32. The housing space 32, partitioned by the partition 50, accommodates the housings 10. The partition 50 is capable of changing a mating location with the first mating groove 33A or the second mating groove 33B.

The electrical connector 1 (e.g., the electrical connector 1A) copes with a configuration of the case 30 in which the electric wire 200 is pulled out toward the forward side F of the mating connector 100, for example, by inserting the partition 50 into the first mating groove 33A, accommodating the first housing 10A in the second housing space 32B on the right side of the paper plane of FIG. 6, and accommodating the second housing 10B in the first housing space 32A on the left side of the paper plane, as illustrated in FIG. 6.

The electrical connector 1 (e.g., the electrical connector 1B) copes with a configuration of the case 30 where the electric wire 200 is pulled out toward the backward side B of the mating connector 100 by inserting the partition 50 into the second mating groove 33B, accommodating the second housing 10B in the second housing space 32B on the right side of the paper plane of FIG. 7, and accommodating the first housing 10A in the first housing space 32A on the left side of the paper plane, as illustrated in FIG. 7.

With the electrical connector 1, even if the pull-out direction of the electric wire 200 is changed (e.g., see FIG. 6 and FIG. 7 for different pull-out directions), the location of the partition 50 is changed so that a position change of the housing 10 can be coped with or addressed by one type of case 30. That is, the pull-out direction of the electric wire 200 can be selected with the electrical connector 1 with one type of case 30.

In addition to the above, components described in the above embodiment can be sorted out or appropriately changed into other components without departing from the spirit of the invention.

1. A case, comprising:
a housing space accommodating a plurality of housings arranged side by side in a first direction that intersects a pull-out direction of an electric wire from the case; and
a plurality of partition member fixing parts in which the housings are arranged, the partition member fixing parts are provided in the first direction and are respectively provided offset from a center of the housing space in the first direction.

2. The case of claim 1, wherein the partition member fixing parts are disposed symmetrically with respect to the center of the housing space.

3. The case of claim 1, wherein the partition member fixing parts include a first mating groove and a second mating groove.

4. The case of claim 3, wherein the first mating groove and the second mating groove are parallel to each other.

5. The case of claim 3, wherein a partition is inserted into the first mating groove or the second mating groove, the partition divides the housing space in the first direction.

6. The case of claim 5, wherein the partition divides the housing space into a first housing space and a second housing space, a dimension of the first housing space in the first direction is different than a dimension of the second housing space in the first direction.

7. The case of claim 3, wherein a central guide is formed in a case body of the case, the central guide is provided between the first mating groove and the second mating groove.

8. The case of claim 7, wherein the first mating groove and the second mating groove are formed in the case body.

9. The case of claim 8, wherein a right guide and a left guide are formed in the case body, the right guide is provided on a rightward side of the first mating groove and the left guide is provided on a leftward side of the second mating groove.

10. The case of claim 9, wherein a partition is inserted into the first mating groove or the second mating groove, the partition divides the housing space in the first direction.

11. The case of claim 10, wherein the partition inserted into the first mating groove contacts the central guide and the right guide, the partition inserted into the second mating groove contacts the central guide and the left guide.

12. A partition, comprising:
a partition part detachably attached to a case and dividing a housing space of the case, the housing space accommodates a plurality of housings arranged side by side in a first direction that intersects a pull-out direction of an electric wire from the case, the partition asymmetrically divides the housing space in the first direction.

13. The partition of claim 12, wherein the partition is made of an insulating material.

14. The partition of claim 12, wherein the partition is attachable to a plurality of different locations of the case in the first direction.

15. The partition of claim 12, wherein a guide that guides each of the housings is formed when the housings are accommodated in the housing space.

16. The partition of claim 12, further comprising a plurality of abutment parts each formed on a side of the partition part, and a first slope part and a second slope part formed in a pair of corner portions where the partition part and the abutment parts connect with each other.

17. The partition of claim 16, further comprising two pairs of two side guides extending from the partition part, the side guides of each pair of two side guides are set apart from each other and protrude from a side of the partition part in a plate thickness direction of the partition part.

18. The partition plate of claim 12, wherein the partition part has a rectangular plate shape.

19. An electrical connector, comprising:
a case including a housing space and a plurality of partition member fixing parts, the housing space accommodates a plurality of housings arranged side by side in a first direction that intersects a pull-out direction of an electric wire from the case, the partition member fixing parts are provided in the first direction, the partition member fixing parts are respectively provided offset from a center of the housing space in the first direction; and
a partition asymmetrically dividing the housing space in the first direction, the partition is detachably attached to the case.
